(19) United States
(12) Patent Application Publication
(10) Pub. No.: US 2020/0403440 A1
(43) Pub. Date: Dec. 24, 2020

(54) AUTOMATIC TRANSFER SWITCH INCLUDING POWER LINE CARRIER COMMUNICATIONS

(71) Applicant: Champion Power Equipment, Inc., Santa Fe Springs, CA (US)

(72) Inventor: Mark J. Sarder, Waukesha, WI (US)

(21) Appl. No.: 16/446,733

(22) Filed: Jun. 20, 2019

(51) Int. Cl. H02J 9/06; H01H 47/00

(52) U.S. Cl. CPC H02J 9/061; H01H 2300/018; H02J 2009/068; H01H 47/004

(57) ABSTRACT

An automatic transfer switch (ATS) includes a controller in communication with first and second relays via power line carrier (PLC) communications.

### BACKGROUND OF THE INVENTION

Embodiments of the invention relate generally to automatic transfer switches and, more particularly, to an automatic transfer switch (ATS) incorporating power line carrier (PLC) communications.

Under most circumstances, the primary or main power source for a property or building is an electric utility. A property is connected to a utility grid through its circuit breaker box, and electricity flows to the various electrical loads on the property from there. If the utility is the only source of power for a property, the property is subject to power outages required by the utility to perform maintenance or upgrades to the grid and power outages due to damage to the grid caused during various events such as, for example, harsh weather conditions and vehicle collisions with grid equipment. During power outages a property may be without power for an unknown period of time, which could last hours, days, or even weeks, depending on the situation. Lengthy power outages can be damaging to property owners. For example, if a building has an electric furnace, the building would be without heat during a power outage, and pipes in the building could freeze during the cold winter months. As another example, a refrigerator/freezer without power will not be able to maintain the temperature required keep food cold/frozen indefinitely, and a property owner may need to dispose of food that spoils during a long power outage. Power outages may also cause other inconveniences such as, for example, loss of hot water, lighting, and cable/internet.

To mitigate the effects of power outages, some property owners install a secondary or auxiliary power source on their properties. One of the most common secondary power sources is a standby or backup generator that is generally activated only during a power outage. A property owner may elect to manually power on a generator once a power outage occurs. However, a property owner may also install an ATS that automatically transfers from one power source to the other. If an ATS senses a power outage, the ATS switches from utility power to generator power. The ATS then continuously monitors the utility grid to determine whether the power outage has ended and reconnects to the utility grid when normal power returns. Thus, an ATS is especially useful when the property owner is not on the premises to activate and deactivate the generator.

An ATS controls which power source is connected to supply power by controlling relays associated with each power source. For example, a property will have a utility relay through which a utility grid may supply power and a generator relay through which a generator may supply power. Since the utility is the primary power source, the utility relay is typically in a closed or ON state that enables power to flow from the utility grid. In contrast, the generator relay is typically in an open or OFF state that prevents a connection to the generator.

When a power outage occurs, the ATS switches the utility relay from the closed position to the open position, activates the generator, and then switches the generator relay from the open position to the closed position. It is important for the ATS to control the utility and generator relays such that only one of the relays is in the closed state. If both relays are in the closed state, a cross connection would be established between the utility and the generator in the ATS. Power could then backfeed from the generator into the utility grid, which would create a hazardous condition to anyone performing maintenance on the grid with the assumption that the equipment and conductors are de-energized. Moreover, if the voltage output by the generator is not synchronized with the voltage on the utility grid, heavy cross-currents may cause voltage fluctuations and possibly damage the equipment.

In addition to switching between utility and generator power, an ATS may manage load shedding for the property once the ATS switches to generator power. The National Electric Code (NEC) has specific requirements for a generator that will operate as an emergency or standby power system. For example, the NEC requires that such a generator be sized for the load. In other words, the generator must be rated to power the load to which it will be connected. Ideally, a backup generator would be capable of supplying power to every load on the property (e.g., all loads connected to the circuit breaker box in a residence), but generators of that size are come at a great expense. Thus, property owners generally elect to purchase a generator that is not large enough to power every load on their property.

If a smaller generator is installed, either the generator can only be connected to a load or combination of loads that will never overload the generator or load shedding must be implemented. In a load shedding scenario, an ATS monitors the power demand of the loads to which the generator is connected and evaluates whether the generator is capable of handling the power demand. If the generator is not able to meet the power demanded by all the loads to which it is connected, the ATS must disconnect one or more of the loads from the generator until the power demand decreases to a level that the generator can meet. Thus, each of the different loads that may shed by the ATS requires its own relay or contactor that the ATS can switch between a closed state and an open state to selectively isolate the load from the generator.

An ATS typically controls the switching of the utility and generator relays and the load shedding relays and detects the position of the utility and generator relays using wired connections. Separate conductors are required for controlling the relays and determining the position of the relays in addition to those through which power flows to from the power sources to the loads. These conductors can be complicated and time consuming to install in an organized fashion, especially when an ATS needs the capability to shed a large number of loads such as, for example, when a property owner wants to use a small generator with as many loads as possible connected to it. A large number of these conductors will also take up a large amount of space and increase the number of components to inspect and/or replace if maintenance is required. Thus, an ATS with large number of control and position detection conductors is inefficient.

Therefore, it would be desirable to provide an ATS with a more efficient system that reduces the number of components and, therefore, installation time and a method of operation thereof.

### BRIEF DESCRIPTION OF THE INVENTION

Embodiments of the present invention provide an ATS with PLC communications and a method of operating the ATS using the PLC communications.

In accordance with one aspect of the invention, an ATS includes a controller in communication with first and second relays via PLC communications.

Various other features and advantages of the present invention will be made apparent from the following detailed description and the drawings.

### BRIEF DESCRIPTION OF THE DRAWINGS

The drawings illustrate preferred embodiments presently contemplated for carrying out the invention.

In the drawings:

FIG. 1 is a block diagram of an electrical distribution system including an ATS, according to an embodiment of the invention.

FIG. 2 is a schematic diagram of the electrical distribution system of FIG. 1, according to an embodiment of the invention.

FIG. 3 is a front view of the ATS of FIGS. 1-2, according to an embodiment of the invention.

FIG. 4 is a schematic of a load shed module for use in the electrical distribution system of FIGS. 1-2, according to an embodiment of the invention.

FIG. 5 is a flowchart illustrating a technique for switching from a primary power source to a secondary power source, according to an embodiment of the invention.

FIG. 6 is a flowchart illustrating a technique for switching from a secondary power source to a primary power source, according to an embodiment of the invention.

FIG. 7 is a flowchart illustrating a technique for adding loads to be powered by a secondary power source, according to an embodiment of the invention.

FIG. 8 is a flowchart illustrating a technique for shedding loads being powered by a secondary power source, according to an embodiment of the invention.

### DETAILED DESCRIPTION

Embodiments of the invention relate to an ATS and a method of operation thereof. Embodiments of the ATS and method of operation disclosed herein differ from prior art systems by using PLC communications rather than wired connections. PLC communications carry data on a conductor that is used simultaneously for AC power transmission/distribution by transmitting a modulated carrier signal at a higher frequency band, such as, for example, kHz or MHz, than the AC power, which is typically transmitted at 50 or 60 Hz, depending on location. The ATS disclosed herein includes a controller with PLC modules that are used to detect the state of the relays that allow primary and secondary power sources to supply power to a load, to communicate with a controller associated with the secondary power source, and to control loading shedding while the secondary power source is supplying power to the load.

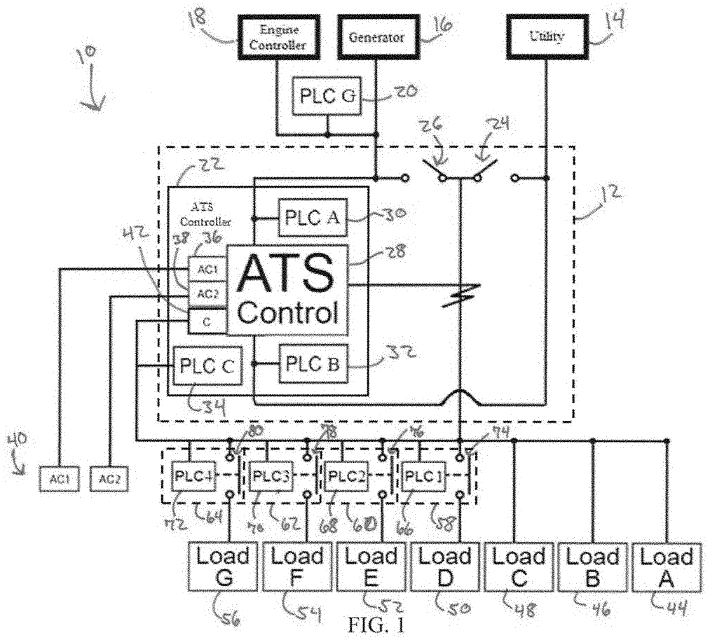

Referring to FIG. 1, a block diagram of an electrical distribution system 10 including an ATS 12 is shown, according to an embodiment of the invention. The electrical distribution system 10 also includes a primary or main power source 14 and a secondary or auxiliary power source 16. In the embodiment of FIG. 1, primary power source 14 is an electric utility, and secondary power source 16 is a standby or backup generator. However, power sources 14, 16 may be other types of power sources such as distributed energy resources including solar, wind, hydroelectric, and battery storage systems, as non-limiting examples. Generator 16 is an engine-driven, electrical generator having an engine controller 18 capable of communicating with ATS 12 via a PLC module or unit 20 (hereinafter “PLC G”). PLC G is a PLC transceiver in the embodiment shown in FIG. 1. In other embodiments, PLC G may be a PLC receiver or PLC transmitter. Engine controller 18 controls the engine (not shown) of generator 16 and also monitors for and protects generator 16 from various conditions including over speed, under speed, low oil pressure, high temperature, high voltage, and low voltage conditions. In some embodiments, generator 16 may include a display that has various status indicators such as, for example, DC voltage, running hours, generator operating status, ATS status, and an exercise timer.

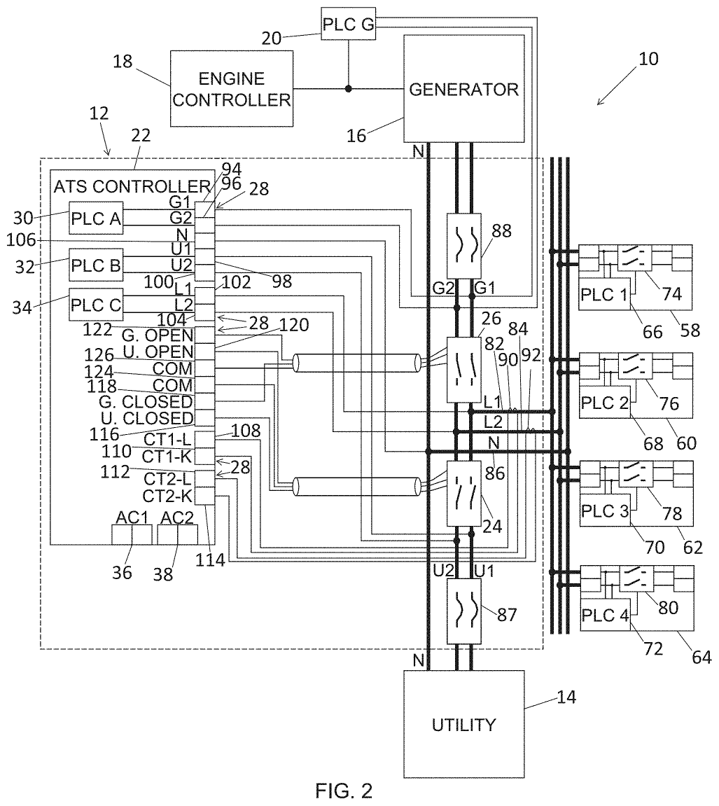

ATS 12 includes a control system or controller 22 that controls a utility relay 24 and a generator relay 26. Utility relay 24 and generator relay 26 are selectively operable in a closed or ON state in which power may flow from utility 14 or generator 16, respectively, and in an open or OFF state which does not allow power to flow therethrough. In the embodiment of FIG. 1, utility relay 24 and generator relay 26 are magnetic latching relays. However, in other embodiments, utility relay 24 and generator relay 26 may be another type of relay such as a mechanical latching relay or a non-latching relay. ATS controller 22 includes various control inputs and outputs 28 described in greater detail with respect to FIG. 2 below. ATS controller 22 further includes three PLC modules or units 30, 32, 34 (hereinafter “PLC A,” “PLC B,” and “PLC C,” respectively) for communicating with other PLC modules in electrical distribution system 10, two AC inputs 36, 38 that receive power for controller 22 from a power source 40, and a common connection 42.

In the embodiment shown in FIG. 1, PLCs A, B, and C are PLC transceivers. In other embodiments, PLCs A, B, and C may be PLC receivers or PLC transmitters, depending on their application. PLC A is in communication with PLC G associated with engine controller 18 of generator 16 and generator latching relay 26. PLC A receives communications from engine controller 18 via PLC G and transmits commands to PLC G for engine controller 18. PLC B is in communication with utility relay 24. PLC C is in communication with both utility relay 24 and generator relay 26. PLC A may communicate with PLC C when generator relay 26 is in the ON state, and PLC B may communicate with PLC C when utility relay 24 is in the ON state.

ATS controller 22 may determine the position of utility relay 24 and generator relay 26 via PLCs A, B, and C. In order to determine the position of generator relay 26, ATS controller 22 transmits a signal from PLC A to PLC C. If PLC C does not receive the signal within a predetermined period of time, controller 22 determines that generator relay 26 is in the OFF state. If PLC C receives the signal within the predetermined period of time, ATS controller 22 determines that generator relay 26 is in the ON state. Similarly, ATS controller 22 may determine the position of utility relay 24 by transmitting a signal from PLC B to PLC C. If PLC C does not receive the signal within a predetermined period of time, ATS controller 22 determines that utility relay 24 is in the OFF state. If PLC C receives the signal within the predetermined period of time, ATS controller 22 determines that utility relay 24 is in the ON state. Thus, ATS controller 22 is able to determine the position of utility relay 24 and generator relay 26 without the need for additional control wires from ATS controller 22 to utility relay 24 and generator relay 26.

Electrical power distribution system 10 further includes a number of loads 44-56 (hereinafter “Load A,” “Load B,” “Load C,” “Load D,” “Load E,” “Load F,” and “Load G,” respectively). Power may flow from utility 14 or generator 16 directly to Loads A-C. Thus, in order for generator 16 to supply power to electrical distribution system 10, generator 16 must supply at least enough power to support Loads A-C. However, power flows from utility 14 or generator 16 to Loads D, E, F, G via load shed modules or units 58, 60, 62, 64, respectively. Each of loads shed modules 58, 60, 62 64 includes a respective PLC module or unit 66, 68, 70, 72 (hereinafter “PLC 1,” “PLC 2,” “PLC 3,” and “PLC4,” respectively) and a respective contactor 74, 76, 78, 80 operable in a closed or ON state in which power may flow to Loads D-G and an open or OFF state in which power cannot flow to Loads D-G. ATS controller 22 controls load shed modules 58-64 via signals transmitted from PLC C to PLCs 1-4, which in turn control their respective contactors 74-80.

Loads A-C connected directly to utility 14 or generator 16 are high priority or critical loads that always need to receive power. High priority loads are selected based on location and need. As a non-limiting example, a high priority load in a cold weather environment may include a furnace, while a high priority load in a hot weather environment may include an air conditioner. Other high priority loads may include a refrigerator or a water heater. Loads D-G are lower priority loads that may be important, but non-critical, loads or non-critical loads. As a non-limiting example, the lower priority loads may include lighting, laundry appliances, and air conditioning. Loads D-G always receive power when utility 14 is the connected power source. However, Loads D-G are only added to the overall load when generator 16 is the connected power source if generator 16 is producing enough power.

Since utility 14 is the primary source of power, ATS controller 22 typically operates utility relay 24 in the ON state to allow power to flow from utility 14 to loads A-G. When utility 14 is in the ON state, ATS controller 22 operates generator relay 26 is in the OFF state to prevent utility 14 and generator 16 from being connected to each other. Further, when utility relay 24 is on the ON state, ATS controller 22 controls load shed modules 58-64 to allow power to flow to each of Loads D-G.

If utility 14 experiences a power outage, ATS controller 22 senses the power outage and switches utility relay 24 from the ON state to the OFF state. ATS controller 22 also transmits a signal from PLC A to PLC G associated with engine controller 18 to start generator 16. ATS controller 22 continues to communicate with engine controller 18 to determine the status of generator 16. Once generator 16 is capable of supplying power to at least Loads A, B, and C, ATS controller 22 switches generator relay 26 from the OFF state to the ON state. If generator 16 is supplying more power than is necessary to power Loads A-C, ATS controller 22 controls load shed modules 58-64 to add one of Loads D-G until either all of Loads D-G are receiving power from generator 16 or generator 16 is not able to supply power to any additional loads.

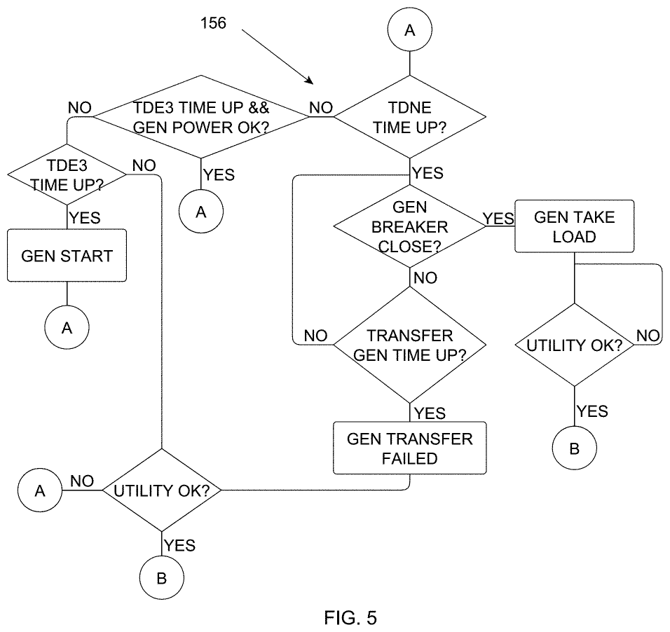

Once ATS controller 22 senses that utility 14 is no longer experiencing a power outage, ATS controller 22 controls generator relay 26 to return to the OFF state and communicates with engine controller 18 to shut down generator 16. Once ATS controller 22 determines that generator relay 26 is in the OFF state, ATS controller 22 controls utility relay 24 to return to the ON state. ATS controller 22 may also control generator relay 26 to return to the OFF state if ATS controller 22 detects that generator 16 is experiencing a fault condition or if generator 16 is no longer capable of supply power to Loads A-C such as, for example, when generator 16 runs out of fuel. The operation of utility relay 24, generator relay 26, and load shed modules 58-64 will be described in more detail below with respect to FIGS. 5-8.

Referring now to FIG. 2, a schematic diagram of electrical distribution system 10 of FIG. 1 is shown, according to an embodiment of the invention. FIG. 2 illustrates the electrical connections between the components of electrical distribution system 10 in greater detail. In addition to the components described above with respect to FIG. 1, ATS 12 includes two AC line busbars 82, 84 and a neutral busbar 86. ATS 12 further includes a utility circuit breaker 87 and a generator circuit breaker 88 to interrupt current flow after a fault is detected in utility 14 or generator 16, respectively. ATS 12 also includes two current transformers 90, 92 measuring the current through line busbars 82, 84, respectively.

Control inputs and outputs 28 of ATS controller 22 are also shown in FIG. 2. ATS controller 22 includes two input/output pins 94, 96 for PLC A, two input/output pins 98, 100 for PLC B, and two input/output pins 102, 104 for PLC C. Input/output pins 94, 96 coupled PLC A to line busbars 82, 84, respectively, between generator relay 26 and generator circuit breaker 88. PLC G is also coupled to line busbars 82, 84 between generator relay 26 and generator circuit breaker 88 such that PLC G is able to communicate with PLC A regardless of the states of generator relay 26 and generator circuit breaker 88. Input/output pins 98, 100 couple PLC B to line busbars 82, 84 between utility relay 24 and utility circuit breaker 87. Input/output pins 102, 104 coupled PLC C to line busbars between utility relay 24 and generator relay 26.

ATS controller 22 additionally includes a neutral pin 106 coupled to neutral busbar 86. ATS controller also includes four input pins 108, 110, 112, 114 for receiving the current sensed by current transformers 90, 92. In addition, ATS controller 22 includes an output pin 116 for transmitting a utility relay close signal to utility relay 24 to move utility relay 24 into the ON state, an output pin 118 for transmitting a generator relay close signal to generator relay 26 to move generator relay into the ON state, an output pin 120 for transmitting a utility relay open signal to move utility relay 24 into the OFF state, and an output pin 122 for transmitting a generator open signal to generator relay 26 to move generator relay into the OFF state. ATS further includes two common pins 124, 126 coupled to utility relay 24 and generator relay 26, respectively.

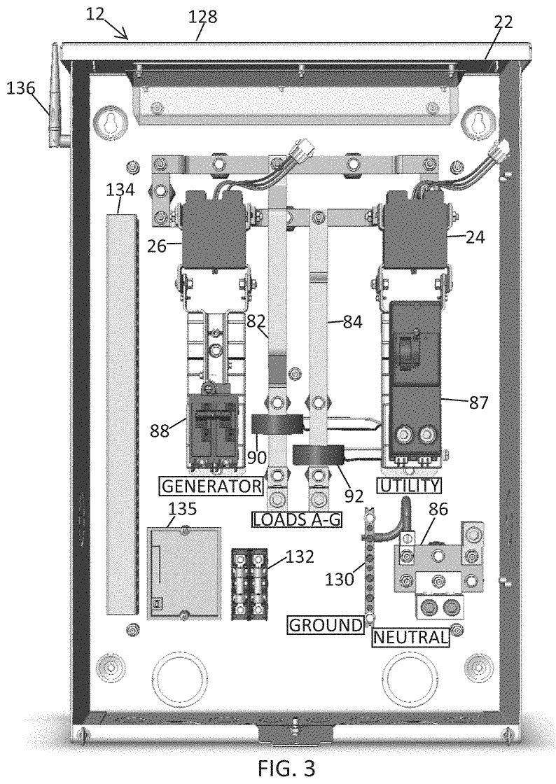

Referring now to FIG. 3, a front view of ATS 12 of FIGS. 1-2 is shown, according to an embodiment of the invention. FIG. 3 illustrates the physical arrangement of the various components of ATS 12 within a housing 128. In addition to the components of ATS 12 described above in FIGS. 1-2, ATS 12 includes a ground lug 130 coupled to neutral busbar 86, a fuse block 132 for utility 14, and a wiring duct and cover 134. In the embodiment shown in FIG. 3, ground lug 130 is an eight-position ground lug but may have a different number of positioned in other embodiments. Further, in some embodiments, fuse block 132 may include two 10A, 600V fuses.

ATS 12 also includes a WIFI module 135 and a WIFI antenna 136, which is positioned on an outer wall of housing 128. WIFI module and WIFI antenna 136 allow a user to communicate with ATS 12 remotely. The remote communications may allow a user to make changes to the ATS programming including, as non-limiting examples, changing the current settings of ATS controller 22 with respect to load shedding or the control of generator 16. The remote communications may also allow a user to obtain a status of electrical distribution system 10 including, as non-limiting examples, whether utility 14 or generator 16 is supplying power to Loads A-G, how much fuel is remaining in generator 16, and, if generator 16 is supplying power, which of Loads A-G, if any, are receiving power.

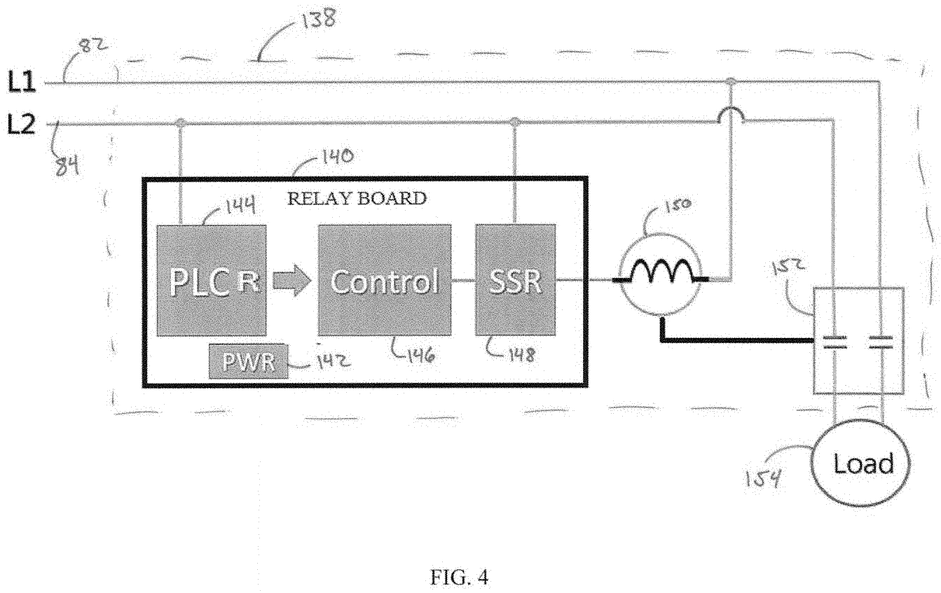

Referring now to FIG. 4, a schematic of a load shed module 138 useable in electrical distribution system 10 of FIGS. 1-2 is shown, according to an embodiment of the invention. Load shed module 138 includes a relay board 140 having a power source 142, a PLC module or unit 144 (hereinafter “PLC R”), a control circuit 146, and a sold-state relay (SSR) 148 operable in a closed or ON state and an open or OFF state. In the embodiment shown in FIG. 4, PLC R is a PLC receiver but may be a PLC transceiver in other embodiments. Load shed module 138 further includes a coil 150 that activates a contactor 152 operable in a closed or ON state that allows power to flow from line busbars 82, 84 to a load 154 and an open or OFF state that prevents power from flowing to load 154. Relay board 140 operates according to commands from PLC C of ATS controller 22 of ATS 12 (FIGS. 1-2).

ATS controller 22 transmits signals from PLC C to PLC R based on the power flowing from utility 14 or generator 16. If utility 14 is supplying power to electrical distribution system 10 or if generator 16 has excess power after supplying power to any loads directly connected thereto, ATS controller 22 transmits a signal to PLC R to operate contactor 152 in the ON state to supply power to load 154. When PLC R receives the signal from PLC C to supply power to load 154, PLC R activates control circuit 146, which then powers on SSR 148. When SSR 148 is in the ON state, SSR 148 allows power to flow through coil 150 between line busbars 82, 84. When power flows through coil 150, coils 150 is activated to close contactor 152. Upon closing of contactor 152, load 154 receives power from line busbars 82, 84.

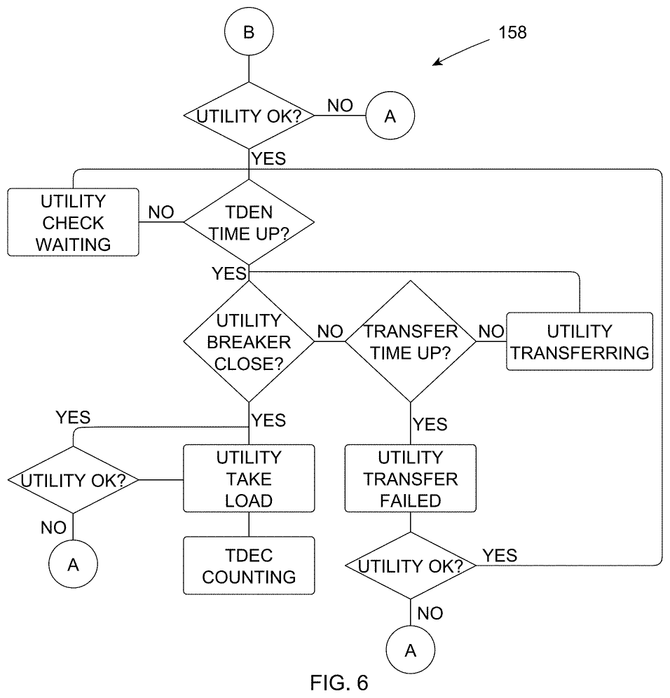

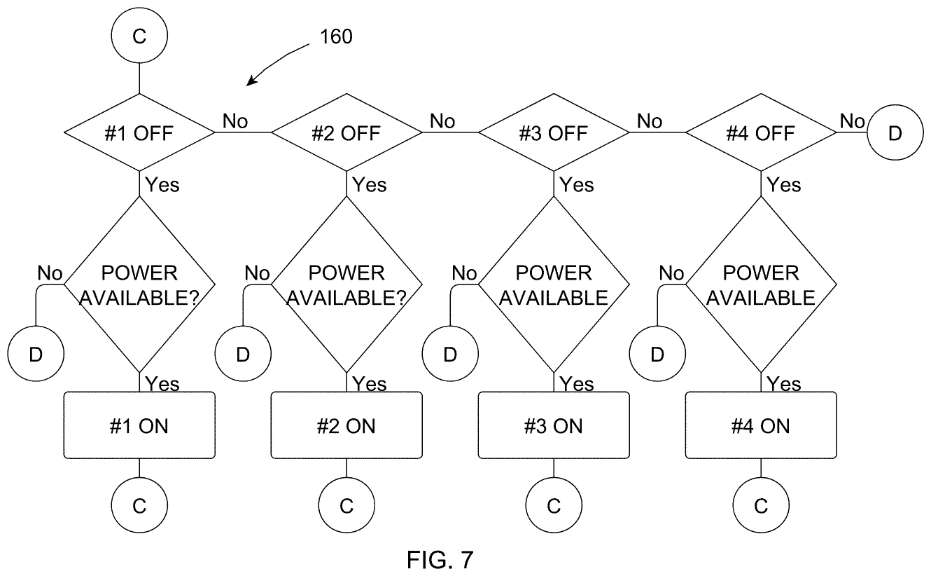

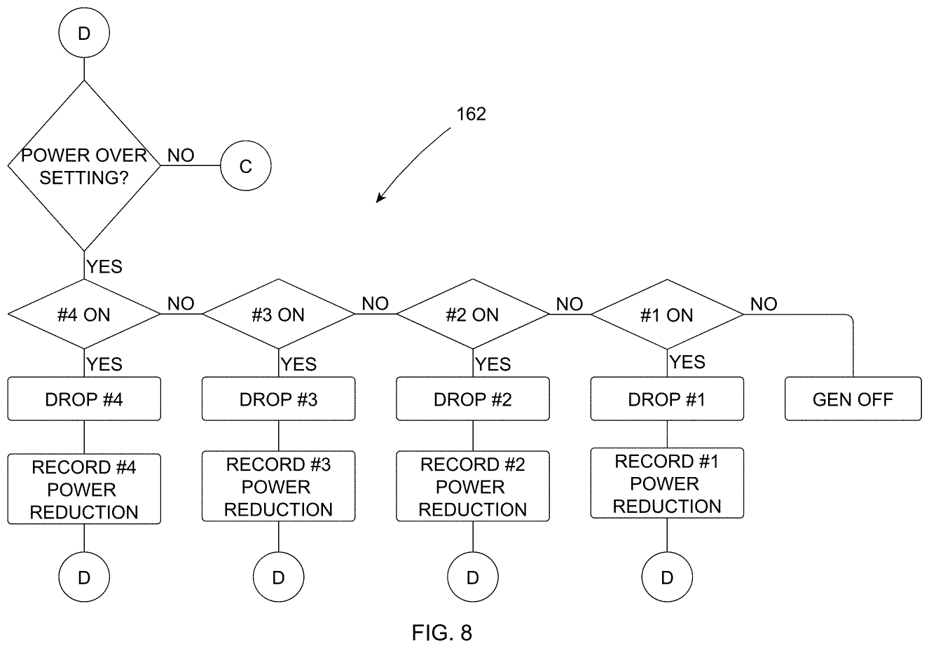

Referring now to FIGS. 5-6, techniques 156, 158 are illustrated for switching between utility 14 and generator 16 using ATS controller 22, according to an embodiment of the invention. Referring now to FIGS. 7-8, techniques 160, 162 are illustrated for adding and shedding loads using ATS controller 22, according to an embodiment of the invention.

Beneficially, embodiments of the invention thus provide an ATS including first and second relays that allow primary and secondary power sources to supply power to a load and a controller including PLC modules in communication with the first and second relays. The controller may use the PLC modules to determine whether the first and second relays are in the ON or OFF state without the need for additional control wires to the first and second relays. The controller may also communicate with a controller associated with the secondary power source in order to operate the secondary power source and to control loading shedding at the load while the secondary power source is supplying power to the load.

According to one embodiment of the present invention, an ATS includes a controller in communication with first and second relays via PLC communications.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

1. An automatic transfer switch (ATS) comprising a controller in communication with first and second relays via power line carrier (PLC) communications.

2. The ATS of claim 1 wherein the first and second relays are magnetic latching relays.

3. The ATS of claim 1 wherein the PLC communications comprise a plurality of PLC modules.

4. The ATS of claim 3 wherein the plurality of PLC modules comprises:
a first PLC module in communication with the first relay;
a second PLC module in communication with the second relay; and
a third PLC module in communication with the first and second relays.

5. The ATS of claim 4 wherein the controller determines the position of the first relay by transmitting a signal from the first PLC module to the third PLC module; and
wherein the controller determines the position of the second relay by transmitting a signal from the second PLC module to the third PLC module.

6. The ATS of claim 4 wherein the first PLC module is in communication with a fourth PLC module associated with an engine of a generator.

7. The ATS of claim 4 wherein the third PLC module is in communication with at least one load shed PLC module associated with a load shed module having a contactor operable in a closed state in which power may flow to a load and an open state in which power cannot flow to the load.

8. The ATS of claim 7 wherein the controller controls the contactor of the load shed module by transmitting a signal from the third PLC module to the at least one load shed PLC module.
